(19) United States
(12) Patent Application Publication
(10) Pub. No.: US 2022/0129655 A1
(43) Pub. Date: Apr. 28, 2022

(54) PROCESSING DEVICE, PROCESSING METHOD, AND NON-TRANSITORY STORAGE MEDIUM

(71) Applicant: NEC Corporation, Minato-ku, Tokyo (JP)

(72) Inventors: Shinya YAMASAKI, Tokyo (JP); Kota IWAMOTO, Tokyo (JP); Soma SHIRAISHI, Tokyo (JP)

(73) Assignee: NEC Corporation, Minato-ku, Tokyo (JP)

(21) Appl. No.: 17/431,273

(22) PCT Filed: Feb. 14, 2020
(86) PCT No.: PCT/JP2020/005794

§ 371 Date: Aug. 16, 2021

(30) Foreign Application Priority Data
Feb. 20, 2019 (JP) 2019-028434

(51) Int. Cl. G06K 7/14; G06V 10/46

(52) U.S. Cl. CPC G06K 7/1443; G06K 7/1452; G06K 7/1413; G06V 10/46

(57) ABSTRACT

The present invention provides a processing apparatus (10) including: an object area determination unit (11) that estimates an area within an image where an object is located; an appearance product determination unit (12) that determines product identification information of the object, based on an appearance feature of the object; a code area determination unit (13) that estimates an area within the image where a code is located; a code product determination unit (14) that determines product identification information indicated by the code; a correlation unit (15) that determines a pair of the object and the code in which areas estimated to be located within the image overlap each other; and a determination unit (16) that determines product identification information of a product included in the image, based on the product identification information determined by the appearance product determination unit (12), the product identification information determined by the code product determination unit (14), and correlation information indicating the pair determined by the correlation unit (15).

### TECHNICAL FIELD

The present invention relates to a processing apparatus, a processing method, and a program.

### BACKGROUND ART

An apparatus disclosed in Patent Document 1 inquires, about an object within an image, simultaneously of both an image recognition engine for recognizing an object within an image, based on similarity with respect to a reference image, and an image recognition engine for recognizing an object within an image by recognizing a barcode within the image, and adopts a recognition result having a highest reliability from recognition results of a plurality of engines.

### RELATED DOCUMENT

### Patent Document

[Patent Document 1] Japanese Patent Application Publication No. 2018-181081

### DISCLOSURE OF THE INVENTION

### Technical Problem

Accuracy of recognizing a product by an image analysis is enhanced by recognizing a product included in an image by a plurality of image analysis methods, and recognizing the product included in the image, based on a recognition result by each of the plurality of image analysis methods. However, in a case where it is necessary to collect a recognition result by each of the plurality of image analysis methods for a same object, when collecting accuracy is low, accuracy of recognizing a product by an image analysis may be lowered. Patent Document 1 does not disclose a means for solving the problem.

The present invention has a challenge to provide a technique for collecting a recognition result by each of a plurality of image analysis methods for a same object.

### Solution to Problem

The present invention provides a processing apparatus including:

an object area determination means for determining an object area being an area indicating an outer shape of an object within an image;

a code area determination means for determining a code area being an area indicating an outer shape of a code within the image;

a code product determination means for determining product identification information indicated by the code; and

a correlation means for correlating the object and the product identification information, when the object area and the code area overlap each other.

Further, the present invention provides a processing method, by a computer, to execute:

an object area determination step of determining an object area being an area indicating an outer shape of an object within an image;

a code area determination step of determining a code area being an area indicating an outer shape of a code within the image;

a code product determination step of determining product identification information indicated by the code; and

a correlation step of correlating the object and the product identification information, when the object area and the code area overlap each other.

Further, the present invention provides a program causing a computer to function as:

an object area determination means for determining an object area being an area indicating an outer shape of an object within an image;

a code area determination means for determining a code area being an area indicating an outer shape of a code within the image;

a code product determination means for determining product identification information indicated by the code; and

a correlation means for correlating the object and the product identification information, when the object area and the code area overlap each other.

Further, the present invention provides a product registration apparatus including:

an image acquisition means for acquiring an image including a plurality of products;

an object area determination means for determining an area indicating an outer shape of each product within the image;

a code area determination means for determining an area indicating an outer shape of a code within the image;

a code product determination means for determining product identification information indicated by a product code;

a correlation means for correlating the product identification information with a position of an outer shape of the product, when an area indicating an outer shape of the product and an area indicating an outer shape of the code overlap each other; and

a product registration means for performing product registration, based on a result of correlation by the correlation means.

### Advantageous Effects of Invention

The present invention achieves a technique for collecting a recognition result by each of a plurality of image analysis methods for a same object.

### BRIEF DESCRIPTION OF THE DRAWINGS

The above-described object, the other objects, features, and advantages will become more apparent from suitable example embodiments described below and the following accompanying drawings.

FIG. 1 is a diagram illustrating one example of a hardware configuration of a processing apparatus according to a present example embodiment.

FIG. 2 is one example of a functional block diagram of the processing apparatus according to the present example embodiment.

FIG. 3 is a diagram schematically illustrating one example of information to be processed by the processing apparatus according to the present example embodiment.

FIG. 4 is a diagram schematically illustrating one example of information to be processed by the processing apparatus according to the present example embodiment.

FIG. 5 is a diagram illustrating processing by the processing apparatus according to the present example embodiment.

FIG. 6 is a diagram schematically illustrating one example of information to be processed by the processing apparatus according to the present example embodiment.

FIG. 7 is a flowchart illustrating one example of a flow of processing by the processing apparatus according to the present example embodiment.

FIG. 8 is a diagram illustrating processing by the processing apparatus according to the present example embodiment.

FIG. 9 is a diagram illustrating processing by the processing apparatus according to the present example embodiment.

FIG. 10 is a flowchart illustrating one example of a flow of processing by the processing apparatus according to the present example embodiment.

FIG. 11 is one example of a functional block diagram of an accounting system according to the present example embodiment.

FIG. 12 is a diagram illustrating an installation example of a camera 20 in the accounting system according to the present example embodiment.

FIG. 13 is a flowchart illustrating one example of a flow of processing by an accounting apparatus according to the present example embodiment.

FIG. 14 is a diagram illustrating one example of information to be output from the processing apparatus according to the present example embodiment.

### DESCRIPTION OF EMBODIMENT

### First Example Embodiment

First, an overview of a present example embodiment is described. In the present example embodiment, a code is attached to a product. The code indicates product identification information. The code may be a barcode, a two-dimensional code, or any other code. The code may be attached to all products, or may be attached to a part of products. When the code is attached to a part of products, the code is attached to a product whose appearance is similar to one or more other products. Specifically, the code is attached to a product that is difficult to be identified only by an appearance feature.

A processing apparatus according to the present example embodiment determines an area (hereinafter, also referred to as an “object area”) indicating an outer shape of an object within an image, and determines product identification information of an object, based on an appearance feature of the object present within the determined object area. Further, the processing apparatus determines an area (hereinafter, also referred to as a “code area”) indicating an outer shape of a code within an image, and determines product identification information indicated by a code present within the determined code area. Subsequently, the processing apparatus correlates an object and a code in which the object area and the code area overlap each other. The processing enables correlating, for a same product, the object area, the code area, the product identification information determined based on an appearance feature of the object, and the product identification information determined based on the code with each other. Then, the processing apparatus determines product identification information of a product included in the image, based on these pieces of information for each product.

Next, a configuration of the processing apparatus is described in detail. First, one example of a hardware configuration of the processing apparatus is described. Each functional unit included in the processing apparatus according to the present example embodiment is achieved by any combination of hardware and software, mainly on the basis of a central processing unit (CPU) of any computer, a memory, a program loaded in the memory, a storage unit (also capable of storing a program downloaded from a storage medium such as a compact disc (CD), a server on the Internet, and the like, in addition to a program stored in advance at a shipment stage of an apparatus) such as a hard disk for storing the program, and a network connection interface. Further, presence of various modification examples of a method and an apparatus for achieving each functional unit is understood by a person skilled in the art.

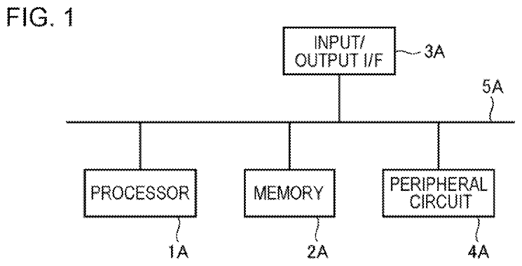

FIG. 1 is a block diagram illustrating a hardware configuration of the processing apparatus according to the present example embodiment. As illustrated in FIG. 1, the processing apparatus includes a processor 1A, a memory 2A, an input/output interface 3A, a peripheral circuit 4A, and a bus 5A. The peripheral circuit 4A includes various modules. The processing apparatus may not include the peripheral circuit 4A. Note that, the processing apparatus may be constituted of a plurality of apparatuses that are separated physically and/or logically. In this case, each of the plurality of apparatuses may have the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU, and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A is able to output a command to each module, and perform arithmetic operation, based on a result of arithmetic operation by each module.

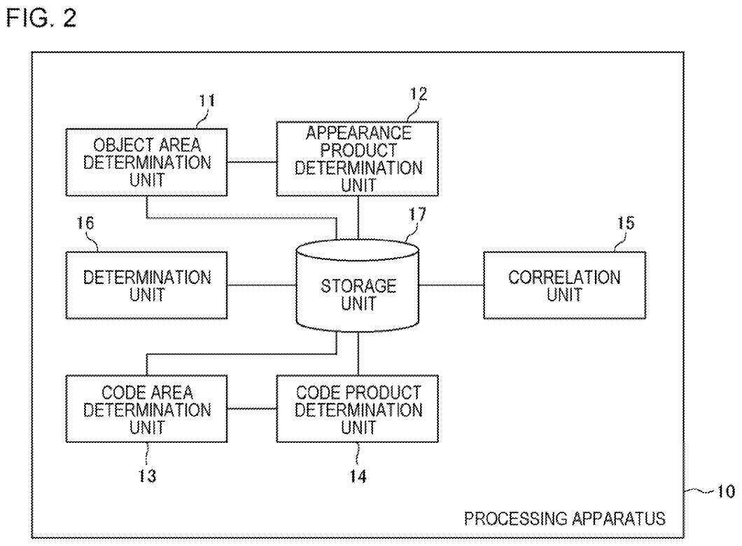

Next, one example of a functional configuration of the processing apparatus is described. As illustrated in the functional block diagram of FIG. 2, a processing apparatus 10 includes an object area determination unit 11, an appearance product determination unit 12, a code area determination unit 13, a code product determination unit 14, a correlation unit 15, a determination unit 16, and a storage unit 17. Note that, the processing apparatus 10 may not include the storage unit 17. In this case, an external apparatus configured to be communicable with the processing apparatus 10 includes the storage unit 17.

The object area determination unit 11 determines an object area being an area indicating an outer shape of an object within an image. For example, the object area determination unit 11 extracts, from an area within an image surrounded by a contour extracted by contour extraction processing, an area (hereinafter, a “size matching area”) whose size satisfies a predetermined condition. Then, the object area determination unit 11 sets, based on a predetermined rule, an area of a predetermined shape (example: a quadrilateral, a circle, and the like) in such a way as to include the extracted size matching area, and determines the set area as an object area. The object area may be set in such a way as to include not only the size matching area, but also a periphery of the size matching area. Further, a plurality of object areas may partially overlap one another. The method described herein is merely one example, and an object area may be determined by another method. Note that, “a first area includes a second area” means that the second area is located within the first area. The above premise is applied to all the following example embodiments.

The object area determination unit 11 causes the storage unit 17 to store information indicating each of a plurality of determined object areas. An object area can be represented by using coordinates of a two-dimensional coordinate system set on an image. For example, in a case where a shape of an object area is a polygonal shape with M sides (where M is an integer of 3 or more), the object area may be represented by coordinates of M vertexes. In addition to the above, when a shape of an object area is a circle, the object area may be represented by center coordinates and a length of a radius of the circle.

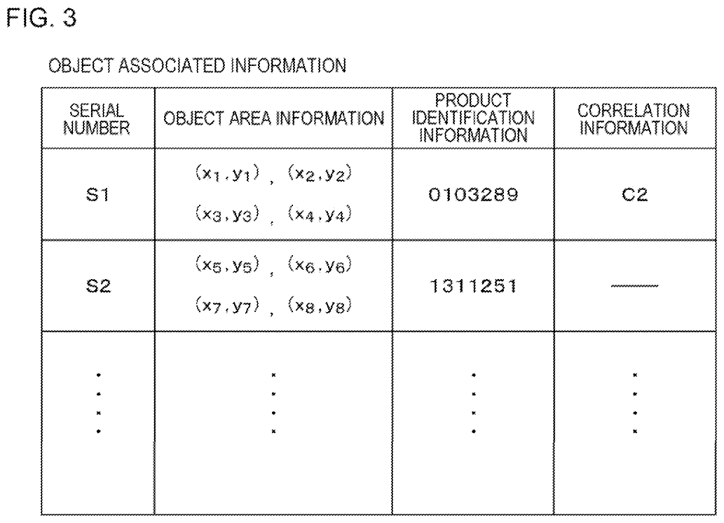

FIG. 3 illustrates one example of object associated information to be stored in the storage unit 17. The illustrated object associated information includes a serial number, object area information, product identification information, and correlation information. The serial number is information for identifying each of a plurality of objects detected from an image. The object area information is information indicating a position of an object area of each of the plurality of objects. In a case of the illustrated example of object area information, a shape of an object area is a quadrilateral, and the object area is represented by coordinates of four vertexes. The illustrated product identification information is information to be generated by the appearance product determination unit 12, and the correlation information is information to be generated by the correlation unit 15. The product identification information and the correlation information are described later.

Referring back to FIG. 2, the appearance product determination unit 12 determines product identification information of an object, based on an appearance feature of the object present within an object area determined by the object area determination unit 11.

For example, the appearance product determination unit 12 is able to achieve the above-described determination by using an estimation model generated by machine learning. Specifically, an operator generates a large number of pieces of training data in which an appearance image of each of a plurality of products and product identification information of each product are correlated. Then, a computer executes machine learning based on the training data, and generates an estimation model for estimating product identification information from an image. Note that, it is possible to adopt any machine learning method.

The appearance product determination unit 12 determines product identification information of an object present within an object area, based on an estimation model generated as described above and an image within the object area determined by the object area determination unit 11. When the object area determination unit 11 determines a plurality of object areas from one image, the appearance product determination unit 12 is able to determine product identification information of each object present within each object area, based on an image within each of the plurality of object areas.

In other example, the appearance product determination unit 12 may determine product identification information of an object by processing of detecting an appearance feature of a product within an image with use of a template matching technique and the like. For example, the appearance product determination unit 12 determines product identification information of an object present within an object area by collating an image within an object area determined by the object area determination unit 11 with a template image. When the object area determination unit 11 estimates a plurality of object areas from one image, the appearance product determination unit 12 is able to determine product identification information of an object present within each of the plurality of object areas by collating an image within each of the plurality of object areas with a template image.

As illustrated in FIG. 3, the appearance product determination unit 12 causes the storage unit 17 to store product identification information of each determined object. The product identification information is information for identifying a plurality of products one from another. The product identification information may be information in which a predetermined number of numerals and/or characters which are arranged, or may be a name of each product, or may be other than the above.

Referring back to FIG. 2, the code area determination unit 13 determines a code area being an area indicating an outer shape of a code within an image. As described above, the code indicates product identification information, and is attached to a product. The code may be a barcode, a two-dimensional code, or any other code. The code may be attached to all products, or the code may be attached to a part of products. When the code is attached to a part of products, the code is attached to a product whose appearance is similar to one or more other products. Specifically, the code is attached to a product that is difficult to be identified only by an appearance feature.

The code area determination unit 13 holds code information indicating an appearance feature of a code. The code area determination unit 13 can detect a code within an image by processing of detecting an appearance feature of a code from an image with use of a template matching technique and the like. Then, the code area determination unit 13 sets, based on a predetermined rule, an area of a predetermined shape (example: a quadrilateral, a circle, and the like) in such a way as to include the appearance feature portion of the detected code, and determines the set area as a code area. Note that, the method described herein is merely one example, and a code area may be estimated by another method.

The code area determination unit 13 causes the storage unit 17 to store information indicating each of a plurality of determined code areas. A code area can be represented by using coordinates of a two-dimensional coordinate system set on an image. For example, in a case where a shape of a code area is a polygonal shape with M sides (where M is an integer of 3 or more), the code area may be represented by coordinates of M vertexes. In addition to the above, when a shape of a code area is a circle, the code area may be represented by center coordinates and a length of a radius of the circle.

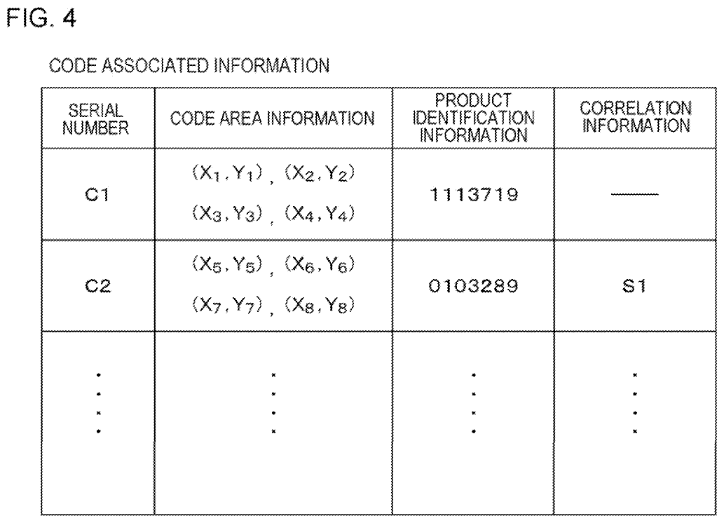

FIG. 4 illustrates one example of code associated information to be stored in the storage unit 17. The illustrated code associated information includes a serial number, code area information, product identification information, and correlation information. The serial number is information for identifying each of a plurality of codes detected from an image. The code area information is information indicating a position of a code area of each of the plurality of codes. In a case of the illustrated example, a shape of a code area is a quadrilateral, and the code area is represented by coordinates of four vertexes. The product identification information is information to be generated by the code product determination unit 14, and the correlation information is information to be generated by the correlation unit 15. The product identification information and the correlation information are described later.

Referring back to FIG. 2, the code product determination unit 14 analyzes a code included in an image, and determines product identification information indicated by the code. The code product determination unit 14 may perform the above-described determination processing, based on an image within a code area determined by the code area determination unit 13. When the code area determination unit 13 determines a plurality of code areas from one image, the code product determination unit 14 determines product identification information indicated by a code located within each code area, based on an image within each of the plurality of code areas. As illustrated in FIG. 4, the code product determination unit 14 causes the storage unit 17 to store product identification information indicated by each determined code.

Referring back to FIG. 2, the correlation unit 15 correlates an object and a code in which a positional relation within an image satisfies a predetermined condition. For example, the correlation unit 15 correlates a pair of an object and a code in which an object area and a code area overlap each other. More specifically, the correlation unit 15 correlates a first code being one code included in an image with an object in which an object area includes a code area of the first code.

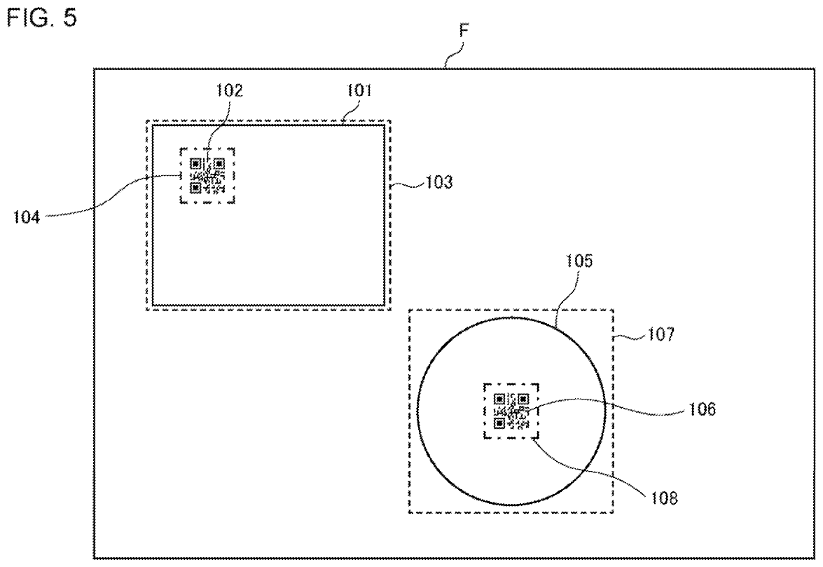

The processing is described with reference to FIG. 5. In FIG. 5, two objects 101 and 105 are included within one image F. A code 102 is attached to the object 101, and a code 106 is attached to the object 105. In the drawing, an object area 103 of the object 101, a code area 104 of the code 102, an object area 107 of the object 105, and a code area 108 of the code 106 are illustrated.

In a case of the illustrated example, the object area 103 of the object 101 includes the code area 104 of the code 102. Therefore, the correlation unit 15 correlates the object 101 with the code 102. Further, in a case of the illustrated example, the object area 107 of the object 105 includes the code area 108 of the code 106. Therefore, the correlation unit 15 correlates the object 105 with the code 106. Performing processing as described above allows the correlation unit 15 to correlate each object with a code attached to each object.

The correlation unit 15 causes the storage unit 17 to store a result of the above correlation. In a case of the example illustrated in FIGS. 3 and 4, the correlation unit 15 writes, in a column of correlation information of object associated information (see FIG. 3), a serial number of a code correlated with each object, and writes, in a column of correlation information of code associated information (see FIG. 4), a serial number of an object correlated with each code. As is clear from FIGS. 3 and 4, performing correlation processing by the correlation unit 15 enables correlating, for a same product, the object area (object area information), the code area (code area information), the product identification information determined based on an appearance feature of the object, and the product identification information determined based on the code with each other.

Referring back to FIG. 2, the determination unit 16 determines product identification information of a product included in an image, based on product identification information (see FIG. 3) determined by the appearance product determination unit 12, product identification information (see FIG. 4) determined by the code product determination unit 14, and a result of correlation by the correlation unit 15.

For example, the determination unit 16 determines, as product identification information of a product included in an image, product identification information of an object that is not correlated with a code (product identification information determined by the appearance product determination unit 12, based on an appearance feature of the object). Further, the determination unit 16 determines, as product identification information of a product included in an image, product identification information of a code that is not correlated with an object (product identification information determined by the code product determination unit 14 by analysis of the code).

Further, the determination unit 16 determines, as product identification information of a product included in an image, either one of product identification information of an object that is correlated with each other (product identification information determined by the appearance product determination unit 12, based on an appearance feature of the object) and product identification information of a code (product identification information determined by the code product determination unit 14 by analysis of the code). For example, the determination unit 16 is able to determine, as product identification information of a product included in an image, product identification information of a code among pieces of product identification information of an object and a code that are correlated with each other. Concerning a result determined by the appearance product determination unit 12 and a result determined by the code product determination unit 14, the result determined by the code product determination unit 14 has a high degree of reliability. Therefore, preferentially adopting a result determined by the code product determination unit 14 enhances reliability of processing of identifying a product, based on an image.

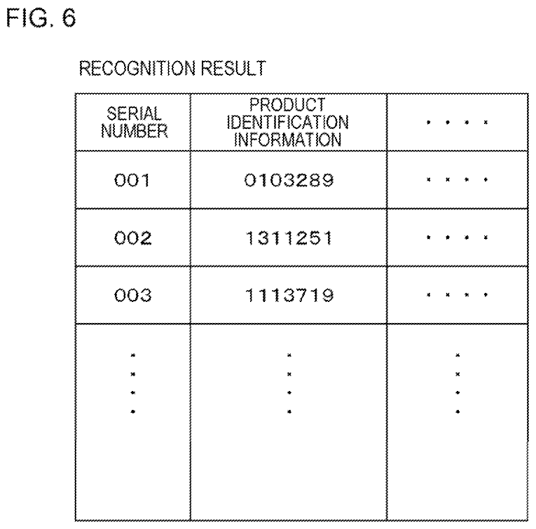

FIG. 6 schematically illustrates one example of a recognition result indicating a content determined by the determination unit 16. The illustrated recognition result includes a serial number of a product that is determined to be included in an image, and product identification information of each product.

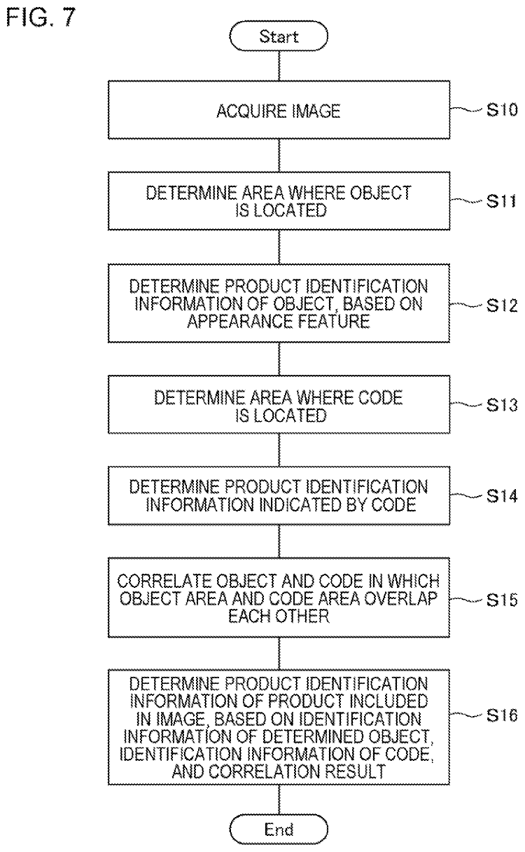

Next, one example of a flow of processing of the processing apparatus 10 is described with reference to a flowchart of FIG. 7.

When the processing apparatus 10 acquires an image (S10), the processing apparatus 10 determines an object area being an area indicating an outer shape of an object within the image (S11). Then, the processing apparatus 10 determines product identification information of the object, based on an appearance feature of the object included in the image within the object area (S12). Since details of these processing by the processing apparatus 10 are as described above, description thereof is omitted herein. When a plurality of object areas are determined from an image, the processing apparatus 10 determines product identification information of each of a plurality of objects, based on an appearance feature of an object included in an image within each of the plurality of object areas.

Further, the processing apparatus 10 determines a code area being an area indicating an outer shape of a code within the image (S13). Then, the processing apparatus 10 analyzes the code included in the image within the code area, and determines product identification information indicated by the code (S14). Since details of these processing by the processing apparatus 10 are as described above, description thereof is omitted herein. When a plurality of code areas are determined from an image, the processing apparatus 10 analyzes a code included in an image within each of the plurality of code areas, and determines product identification information indicated by each of the plurality of codes.

Note that, the order of processing of S11 to S14 is not limited to the example illustrated in FIG. 7, and any other order may be applied.

Next, the processing apparatus 10 correlates an object and a code in which an object area and a code area overlap each other (S15). The processing apparatus 10 is able to correlate a first code within a code determined in S13 with an object in which an object area includes a code area of the first code. Since details of the processing by the processing apparatus 10 are as described above, description thereof is omitted herein.

Next, the processing apparatus 10 determines product identification information of a product included in an image acquired in S10, based on product identification information determined in S12, product identification information determined in S14, and a result of correlation in S15. For example, the processing apparatus 10 determines, as product identification information of a product included in the image, product identification information of an object that is not correlated with a code (product identification information determined based on an appearance feature of the object in S12). Further, the processing apparatus 10 determines, as product identification information of a product included in the image, product identification information of a code that is not correlated with an object (product identification information determined by analysis of the code in S14). Further, the processing apparatus 10 determines, as product identification information of a product included in the image, either one of pieces of product identification information (e.g., product identification information of a code) of an object and a code that are correlated with each other.

The processing apparatus 10 according to the present example embodiment described above is able to recognize a product included in an image by a plurality of image analysis methods (a recognition method based on an appearance feature of a product, and a recognition method based on a code analysis), and recognize the product included in the image, based on a recognition result by each of the plurality of image analysis methods. Therefore, accuracy of recognizing a product by an image analysis is enhanced.

For example, even when there is a group of products similar to one another in appearance among a plurality of products, and it is difficult to identify these products only by an appearance feature, the processing apparatus 10 according to the present example embodiment having the above-described feature is able to identify these products.

Note that, in a case of the processing apparatus 10 according to the present example embodiment, a code may be attached only to a product whose appearance is similar to one or more other products, and a code may not be attached to the other products. In this case, a product whose appearance is not similar to other products is recognized by a recognition method based on an appearance feature of a product, and a product whose appearance is similar to one or more other products is recognized by a recognition method based on a code analysis. When a code is required to be attached only to a part of products, time and labor and cost for attaching a code can be reduced.

Further, the processing apparatus 10 is able to accurately collect a recognition result by each of a plurality of image analysis methods for a same object. Therefore, accuracy of recognizing a product by an image analysis is enhanced.

### Second Example Embodiment

A processing apparatus 10 according to a present example embodiment is different from the processing apparatus 10 according to the first example embodiment in a point that the processing apparatus 10 has a function of, when there are a plurality of object areas including one code area, and it is difficult to correlate one code with one object, determining one object to be correlated with the one code, based on a position of a code area within each of the plurality of object areas. The other configuration of the processing apparatus 10 according to the present example embodiment is similar to that of the processing apparatus 10 according to the first example embodiment.

One example of a hardware configuration of the processing apparatus 10 is similar to that of the processing apparatus 10 according to the first example embodiment.

One example of a functional block diagram of the processing apparatus 10 is illustrated in FIG. 2 similarly to the processing apparatus 10 according to the first example embodiment. Since a configuration of an object area determination unit 11, an appearance product determination unit 12, a code area determination unit 13, a code product determination unit 14, a determination unit 16, and a storage unit 17 is similar to that in the first example embodiment, description thereof is omitted herein.

A correlation unit 15 has a function described in the first example embodiment. When there are a plurality of object areas including a code area of a first code being one code included in an image, the correlation unit 15 determines an object to be correlated with the first code, based on a position of the code area of the first code within each of the plurality of object areas.

Specifically, in the present example embodiment, a position where a code is attached is determined in advance. The position where a code is attached may be, for example, “a center of a surface of a product”, or, when a surface where a code is attached is quadrilateral, the position may be “within a predetermined distance (upper left area) from an upper left vertex on a quadrilateral surface of a product, which is disposed in such a way that a long side extends in a left-right direction, and a short side extends in an up-down direction”, or the position may be any other position.

In the present example embodiment, information (hereinafter, “code position definition information”) indicating “a position (positional relation between an object area and a code area) of a code area within an object area”, which is associated with “a code attaching position that is determined in advance” is stored in advance in the storage unit 17. For example, in a case where “the code attaching position that is determined in advance” is “a center of a surface of a product”, the code position definition information means that “a position of a code area is a center of an object area”. Further, when “the code attaching position that is determined in advance” is “within a predetermined distance (upper left area) from an upper left vertex on a quadrilateral surface of a product, which is disposed in such a way that a long side extends in a left-right direction, and a short side extends in an up-down direction”, the code position definition information means that “a position of a code area is within a predetermined distance from an upper left or lower right vertex of an object area (quadrilateral), which is disposed in such a way that a long side extends in a left-right direction, and a short side extends in an up-down direction”.

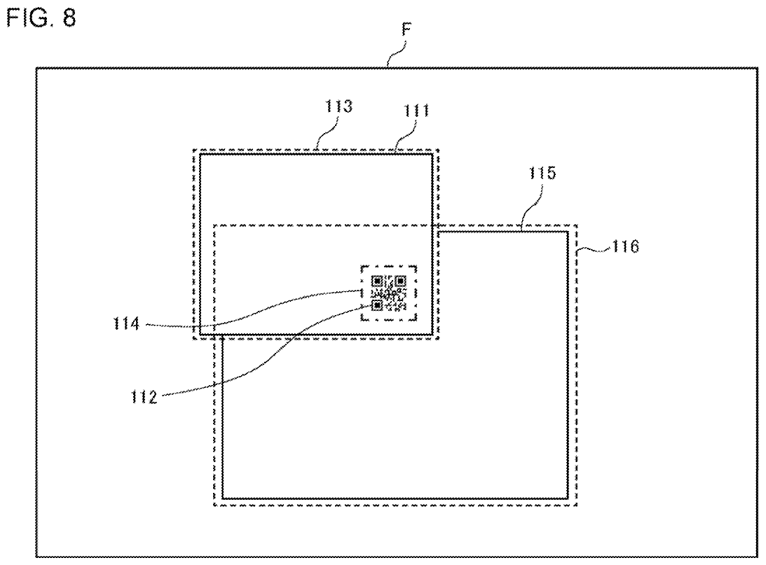

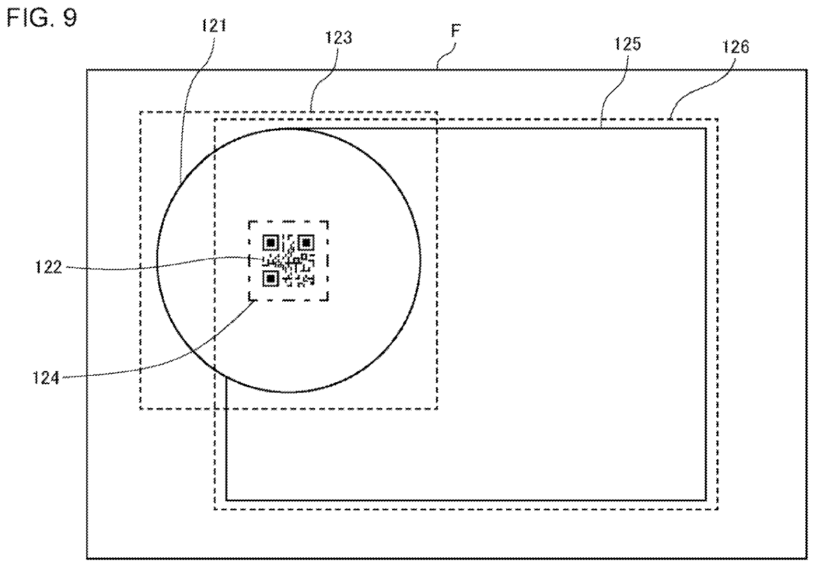

When there are a plurality of object areas including a code area of a first code, the correlation unit 15 correlates, with the first code, an object in which a positional relation between an object area and the code area of the first code satisfies a positional relation indicated by the above-described code position definition information. The processing is described with reference to FIGS. 8 and 9.

In FIG. 8, two objects 111 and 115 are included within one image F. A part of the object 111 and a part of the object 115 overlap each other. The object 111 is located forward (side of a camera for capturing the image F) with respect to the object 115. A code 112 is a code attached to the object 111.

The drawing illustrates an object area 113 of the object 111, a code area 114 of the code 112, and an object area 116 of the object 115.

From the drawing, the correlation unit 15 determines that both of the object area 113 and the object area 116 include the code area 114. In this case, the correlation unit 15 determines whether “a position of the code area 114 within the object area 113” and “a position of the code area 114 within the object area 116” satisfy the code position definition information that is determined in advance.

Herein, it is assumed that the code position definition information means that “a position of a code area is within a predetermined distance from an upper left or lower right vertex of an object area (quadrilateral), which is disposed in such a way that a long side extends in a left-right direction, and a short side extends in an up-down direction”. In this case, from the drawing, the correlation unit 15 determines that a positional relation between the object area 113 and the code area 114 satisfies the code position definition information, and a positional relation between the object area 116 and the code area 114 does not satisfy the code position definition information. Consequently, the correlation unit 15 correlates the object 111 with the code 112.

In FIG. 9, two objects 121 and 125 are included within one image F. A part of the object 121 and a part of the object 125 overlap each other. The object 121 is located forward (side of a camera for capturing the image F) with respect to the object 125. A code 122 is a code attached to the object 121.

The drawing illustrates an object area 123 of the object 121, a code area 124 of the code 122, and an object area 126 of the object 125.

From the drawing, the correlation unit 15 determines that both of the object area 123 and the object area 126 include the code area 124. In this case, the correlation unit 15 determines whether “a position of the code area 124 within the object area 123”, and “a position of the code area 124 within the object area 126” satisfy the code position definition information that is determined in advance.

Herein, it is assumed that the code position definition information means that “a position of a code area is a center of an object area”. In this case, from the drawing, the correlation unit 15 determines that a positional relation between the object area 123 and the code area 124 satisfies the code position definition information, and a positional relation between the object area 126 and the code area 124 does not satisfy the code position definition information. Consequently, the correlation unit 15 correlates the object 121 with the code 122.

In this way, the correlation unit 15 is able to correlate each object with a code attached to each object, even when a plurality of objects overlap one another.

The other configuration of the correlation unit 15 is similar to that of the first example embodiment.

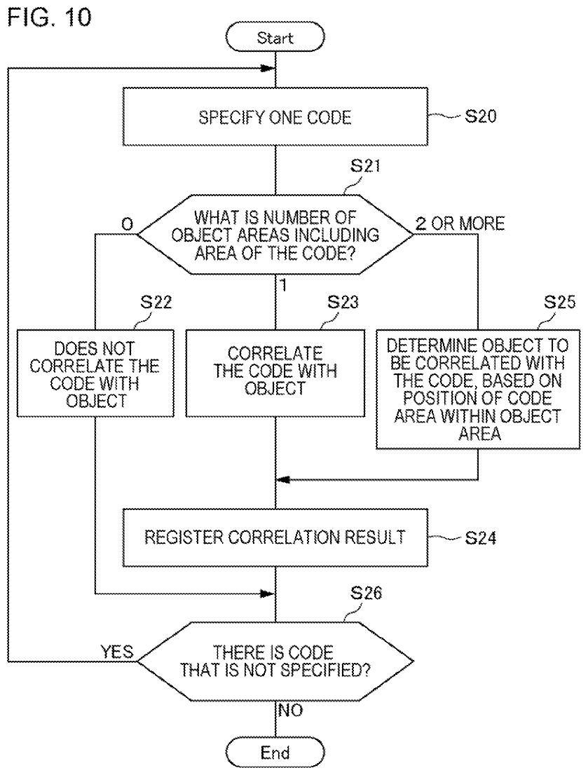

One example of a flow of processing of the processing apparatus 10 according to the present example embodiment is illustrated in the flowchart of FIG. 7 similarly to the first example embodiment. Herein, one example of a flow of processing of S15 in the flowchart of FIG. 7 is described with reference to a flowchart of FIG. 10.

First, the processing apparatus 10 specifies, as a processing target, one of codes for which a code area is determined in S13 in FIG. 7 (S20). Subsequently, the processing apparatus 10 determines an object area including a code area of the code specified in S20, based on the code area of the specified code, and the object area determined in S11 in FIG. 7.

When the number of the determined object areas is 0 (“0” in S21), the processing apparatus 10 does not correlate an object with the specified code (S22).

When the number of the determined object areas is 1 (“1” in S21), the processing apparatus 10 correlates the specified code with one object to be determined within the determined object area (S23). Then, the processing apparatus 10 registers a result of the correlation in the storage unit 17 (S24).

When the number of the determined object areas is two or more (“2 or more” in S21), the processing apparatus 10 determines an object to be correlated with the specified code, based on a position of a code area of the code specified within each of the two or more determined object areas (S25). Then, the processing apparatus 10 registers a result of the correlation in the storage unit 17 (S24). Since details of the processing is as described above, description thereof is omitted herein.

Thereafter, when there is a code that is not specified in S20 among the codes for which a code area is determined in S13 in FIG. 7 (Yes in S26), the processing apparatus 10 returns to S20, and repeats the processing. On the other hand, when there is no code that is not specified in S20 (No in S26), the processing apparatus 10 finishes the processing.

In the processing apparatus 10 according to the present example embodiment described above, an advantageous effect similar to the processing apparatus 10 according to the first example embodiment is achieved. Further, in the processing apparatus 10 according to the present example embodiment, when there are a plurality of object areas including a code area, it is possible to accurately correlate each object with a code attached to each object, based on a positional relation between a code area and each of the plurality of object areas. Therefore, accuracy of recognizing a product by an image analysis is enhanced.

Herein, a modification example of the present example embodiment is described. The above-described code position definition information may be generated for each product, and may be stored in the storage unit 17 in association with product identification information of each product. In the modification example, when one code of a processing target is specified, the correlation unit 15 recognizes product identification information indicated by the code determined by the code product determination unit 14, and acquires code position definition information stored in the storage unit 17 in association with the recognized product identification information. Then, the correlation unit 15 determines whether a code area of the one specified code and each object area estimated by the object area determination unit 11 satisfy the acquired code position definition information. The other processing is as described above. Also in the modification example, the above-described advantageous effect of the present example embodiment is achieved. Further, since a position where a code is attached can be defined for each product, it becomes possible to attach a code to a position suitable for each product according to appearance design and the like of each product.

### Third Example Embodiment

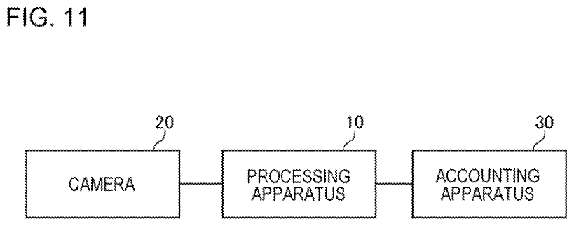

A processing apparatus 10 according to a present example embodiment is used in cooperation with a camera and an accounting apparatus installed at a store and the like. FIG. 11 illustrates one example of a functional block diagram of an accounting system according to the present example embodiment. As illustrated in FIG. 11, the accounting system includes the processing apparatus 10, a camera 20, and an accounting apparatus 30 (example: a point of sales (POS) system). The processing apparatus 10 and the camera 20 communicate with each other wiredly and/or wirelessly. Further, the processing apparatus 10 and the accounting apparatus 30 communicate with each other wiredly and/or wirelessly.

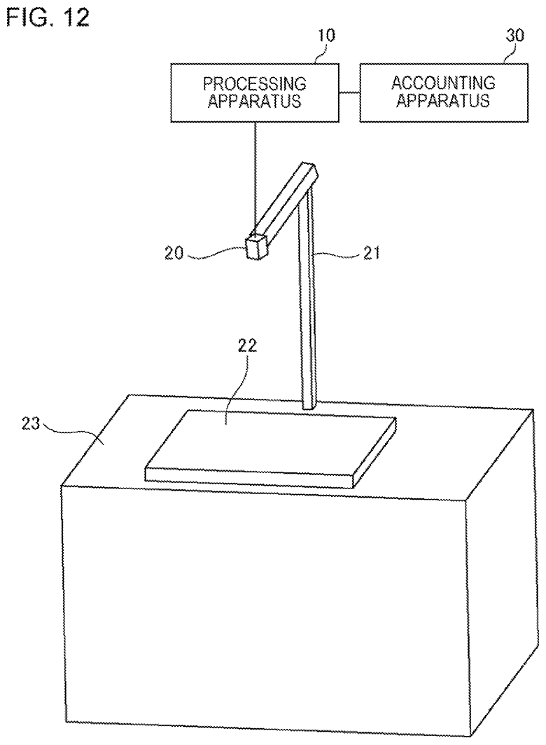

FIG. 12 illustrates an installation example of the camera 20. In the illustrated example, a placement area 22 for placing a product is provided on a table 23. A product being an accounting target is placed on the placement area 22. The camera 20 is connected to a stay 21. The camera 20 is installed at a position and in a direction in which the placement area 22 is captured. Specifically, the camera 20 is installed at a position and in a direction in which a product placed on the placement area 22 is captured from above. The camera 20 transmits generated image data to the processing apparatus 10. Note that, a plurality of cameras 20 may be installed. In this case, at least one camera 20 may be installed on the table 23, and capture a product from a side.

The processing apparatus 10 acquires image data generated by the camera 20. Then, the processing apparatus 10 performs the processing described in the first or second example embodiment, based on the acquired image data, and registers, as a purchasing product, a product correlated with product identification information by determining the product identification information of the product included in an image. Subsequently, in response to detecting pressing of an accounting button by a user, the processing apparatus 10 transmits, to the accounting apparatus 30, a registered product as settlement information. Herein, the settlement information may include a product name, a product price, a product image, and a total payment amount.

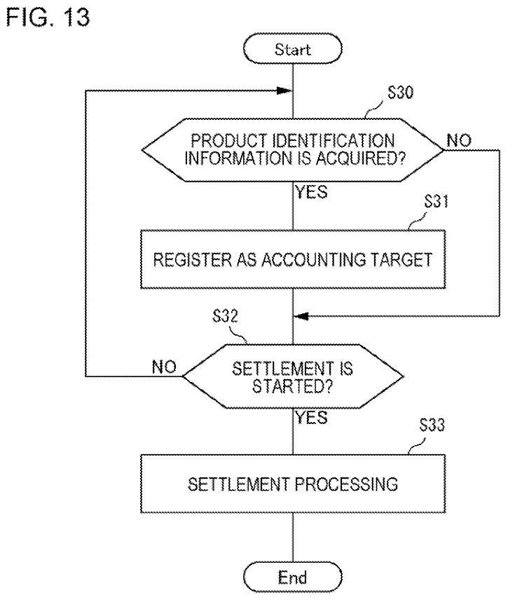

The accounting apparatus 30 performs accounting processing, based on the information received from the processing apparatus 10. One example of a flow of processing of the accounting apparatus 30 is described with reference to a flowchart of FIG. 13.

The accounting apparatus 30 is in a waiting state for product identification information (S30). When the accounting apparatus 30 acquires product identification information (Yes in S30), the accounting apparatus 30 registers, as an accounting target, a product identified by the product identification information (S31). For example, the accounting apparatus 30 refers to a product master registered in advance in a store system and the like, acquires product information (example: a unit price, a product name, and the like) correlated with the acquired product identification information, and registers the acquired product information as an accounting target.

When at least one product is registered as an accounting target, the accounting apparatus 30 is set to an input waiting state in which settlement processing is started (S32), and is set to a waiting state for product identification information (S30).

Then, when the accounting apparatus 30 accepts input of starting settlement processing (Yes in S32), the accounting apparatus 30 performs the settlement processing (S33). For example, the accounting apparatus 30 may accept input of cash, as payment of a total payment amount computed based on a registered product, and give change and issue a receipt as necessary. Further, the accounting apparatus 30 may accept input of credit card information, communicate with a system of a credit card company, and perform transaction processing. Further, the accounting apparatus 30 may transmit, to another settlement apparatus, information for settlement processing (information indicating a registered product, a total payment amount, and the like). Further, the accounting apparatus 30 may accept input of deposit money deposited from a customer, causes a display to display change by computing the change, based on the deposit money, and make payment of the computed change. When the settlement processing is finished, the accounting apparatus 30 is set to a waiting state for product identification information again (S30).

Note that, in FIGS. 11 and 12, the processing apparatus 10 and the accounting apparatus 30 are described individually. Alternatively, the processing apparatus 10 and the accounting apparatus 30 may be separated physically and/or logically, or may be integrated physically and/or logically. When the processing apparatus 10 and the accounting apparatus 30 are integrated physically and/or logically, a product registration apparatus including an image acquisition means for acquiring an image including a plurality of products, an object area determination means for determining an area indicating an outer shape of each product within the image, a code area determination means for determining an area indicating an outer shape of a code within the image, a code product determination means for determining product identification information indicated by a product code, a correlation means for correlating product identification information with a position of an outer shape of the product when an area indicating an outer shape of the product and an area indicating an outer shape of the code overlap each other, and a product registration means for registering a product, based on a result of correlation by the correlation means, is achieved.

In the accounting system according to the present example embodiment described above, an advantageous effect similar to the first and second example embodiments is achieved. Further, since the processing apparatus 10 is able to accurately identify a product, it is possible to reduce manpower required for processing of registering a product as an accounting target.

Herein, a modification example applicable to all the example embodiments is described. The processing apparatus 10 may include an output means for outputting information indicating a result of correlation by the correlation unit 15. Output by the output means can be achieved via every output apparatus such as a display, a speaker, a projection apparatus, a printer, and a mailer.

For example, the output means is able to display, on an image including an object and a code, information indicating each of an object area and a code area, and output an image for identifying an object and a code correlated with each other by a display pattern of the information.

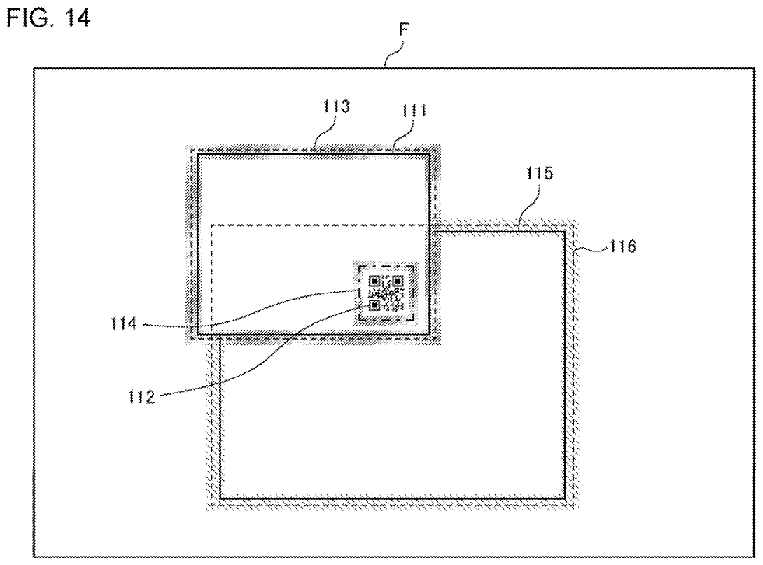

FIG. 14 illustrates one example of information to be output by the output means. In the example, information (example: a frame) indicating object areas 113 and 116 determined by the object area determination unit 11, and information (example: a frame) indicating a code area 114 determined by the code area determination unit 13 are displayed on an image including a plurality of products. The image may be a captured image generated by capturing with use of a camera, or may be a drawn image acquired by determining a position, a shape, and the like of each object, based on a captured image, and drawing an object of a predetermined shape at a predetermined position, based on a determination result.

In the information illustrated in FIG. 14, a frame indicating the object area 113 of an object 111 that is correlated with a code 112 is displayed with a same color as a color of a frame indicating the code area 114 of the code 112. Further, a frame indicating the object area 116 of an object 115 that is not correlated with the code 112 is displayed with a color different from the color of the frame indicating the code area 114 of the code 112. Consequently, the object 111 and the code 112 that are correlated with each other are identifiable by a display pattern of the frame. Note that, in place of a frame color, the object 111 and the code 112 that are correlated with each other may be identifiable by adjusting another display pattern such as a frame shape.

While the present invention has been described with reference to the example embodiments (and examples), the present invention is not limited to the above-described example embodiments (and examples). For example, the above-described plurality of example embodiments (and examples) may be optionally combined. A configuration and details of the present invention may be modified in various ways comprehensible to a person skilled in the art within the scope of the present invention.

A part or all of the above-described example embodiments may also be described as the following supplementary notes, but is not limited to the following.
1. A processing apparatus including:

an object area determination means for determining an object area being an area indicating an outer shape of an object within an image;

a code area determination means for determining a code area being an area indicating an outer shape of a code within the image;

a code product determination means for determining product identification information indicated by the code; and

a correlation means for correlating the object and the product identification information, when the object area and the code area overlap each other.
2. The processing apparatus according to supplementary note 1, wherein

the correlation means correlates a pair of the object and the code in which the object area and the code area overlap each other.
3. The processing apparatus according to supplementary note 2, wherein

the correlation means correlates a first code and the object in which the object area includes the code area of the first code.
4. The processing apparatus according to supplementary note 3, wherein

the correlation means determines, when there are a plurality of the object areas including the code area of the first code, the object to be correlated with the first code, based on a position of the code area of the first code within each of the plurality of object areas.
5. The processing apparatus according to supplementary note 4, wherein

the correlation means correlates the object and the code that satisfy a positional relation defined in advance between the object area and the code area.
6. The processing apparatus according to supplementary note 5, wherein

the correlation means correlates the object and the code that satisfy a positional relation defined, for each product, in advance between the object area and the code area.
7. The processing apparatus according to any one of supplementary notes 2 to 6, further including:

an appearance product determination means for determining product identification information of the object, based on an appearance feature of the object; and

a determination means for determining the product identification information of a product included in the image, based on the product identification information determined by the code product determination means, the product identification information determined by the appearance product determination means, and a result of correlation by the correlation means, wherein

the determination means
determines, as the product identification information of a product included in the image, the product identification information of the object that is not correlated with the code,
determines, as the product identification information of a product included in the image, the product identification information of the code that is not correlated with the object, and
determines, as the product identification information of a product included in the image, either one of the pieces of product identification information of the object and the code that are correlated with each other.
8. The processing apparatus according to supplementary note 7, wherein

the determination means

determines, as the product identification information of a product included in the image, the product identification information of the code among the pieces of product identification information of the object and the code that are correlated with each other.
9. The processing apparatus according to any one of supplementary notes 2 to 8, further including

an output means for displaying, on an image including the object and the code, information indicating each of the object area and the code area, and outputting an image for identifying the object and the code that are correlated with each other by a display pattern of information indicating each of the object area and the code area.
10. A processing method, by a computer, to execute:

an object area determination step of determining an object area being an area indicating an outer shape of an object within an image;

a code area determination step of determining a code area being an area indicating an outer shape of a code within the image;

a code product determination step of determining product identification information indicated by the code; and

a correlation step of correlating the object and the product identification information, when the object area and the code area overlap each other.
11. A program causing a computer to function as:

an object area determination means for determining an object area being an area indicating an outer shape of an object within an image;

a code area determination means for determining a code area being an area indicating an outer shape of a code within the image;

a code product determination means for determining product identification information indicated by the code; and

a correlation means for correlating the object and the product identification information, when the object area and the code area overlap each other.
12. A product registration apparatus including:

an image acquisition means for acquiring an image including a plurality of products;

an object area determination means for determining an area indicating an outer shape of each product within the image;

a code area determination means for determining an area indicating an outer shape of a code within the image;

a code product determination means for determining product identification information indicated by the product code;

a correlation means for correlating the product identification information with a position of an outer shape of the product, when an area indicating an outer shape of the product and an area indicating an outer shape of the code overlap each other; and

a product registration means for performing product registration, based on a result of correlation by the correlation means.

This application is based upon and claims the benefit of priority from Japanese patent application No. 2019-028434, filed on Feb. 20, 2019, the disclosure of which is incorporated herein in its entirety by reference.

What is claimed is:

1. A processing apparatus comprising:
at least one memory configured to store one or more instructions; and
at least one processor configured to execute the one or more instructions to:
determine an object area being an area indicating an outer shape of an object within an image;
determine a code area being an area indicating an outer shape of a code within the image;
determine product identification information indicated by the code; and
correlate the object and the product identification information, when the object area and the code area overlap each other.

2. The processing apparatus according to claim 1,
wherein the processor is further configured to execute the one or more instructions to correlate a pair of the object and the code in which the object area and the code area overlap each other.

3. The processing apparatus according to claim 2,
wherein the processor is further configured to execute the one or more instructions to correlate a first code and the object in which the object area includes the code area of the first code.

4. The processing apparatus according to claim 3,
wherein the processor is further configured to execute the one or more instructions to determine, when there are a plurality of the object areas including the code area of the first code, the object to be correlated with the first code, based on a position of the code area of the first code within each of the plurality of object areas.

5. The processing apparatus according to claim 4,
wherein the processor is further configured to execute the one or more instructions to correlate the object and the code that satisfy a positional relation defined in advance between the object area and the code area.

6. The processing apparatus according to claim 5,
wherein the processor is further configured to execute the one or more instructions to correlate the object and the code that satisfy a positional relation defined, for each product, in advance between the object area and the code area.

7. The processing apparatus according to claim 2,
the processor is further configured to execute the one or more instructions to:
determine product identification information of the object, based on an appearance feature of the object; and
determine the product identification information of a product included in the image, based on the product identification information determined based on the code, the product identification information determined based on an appearance feature of the object, and a result of correlation,
when determining the product identification information of a product included in the image, the processor:
determines, as the product identification information of a product included in the image, the product identification information of the object that is not correlated with the code,
determines, as the product identification information of a product included in the image, the product identification information of the code that is not correlated with the object, and
determines, as the product identification information of a product included in the image, either one of the pieces of product identification information of the object and the code that are correlated with each other.

8. The processing apparatus according to claim 7,
wherein the processor is further configured to execute the one or more instructions to determine, as the product identification information of a product included in the image, the product identification information of the code among the pieces of product identification information of the object and the code that are correlated with each other.

9. The processing apparatus according to claim 2,
the processor is further configured to execute the one or more instructions to output, on an image including the object and the code, information indicating each of the object area and the code area, and output an image for identifying the object and the code that are correlated with each other by a display pattern of information indicating each of the object area and the code area.

10. A processing method, by a computer, to execute:
determining an object area being an area indicating an outer shape of an object within an image;
determining a code area being an area indicating an outer shape of a code within the image;
determining product identification information indicated by the code; and
correlating the object and the product identification information, when the object area and the code area overlap each other.

11. A non-transitory storage medium storing a program causing a computer to:
determine an object area being an area indicating an outer shape of an object within an image;
determine a code area being an area indicating an outer shape of a code within the image;
determine product identification information indicated by the code; and
correlate the object and the product identification information, when the object area and the code area overlap each other.

12. A product registration apparatus comprising:
at least one memory configured to store one or more instructions; and
at least one processor configured to execute the one or more instructions to:
acquire an image including a plurality of products;
determine an area indicating an outer shape of each product within the image;
determine an area indicating an outer shape of a code within the image;
determine product identification information indicated by the product code;
correlate the product identification information with a position of an outer shape of the product, when an area indicating an outer shape of the product and an area indicating an outer shape of the code overlap each other; and
perform product registration, based on a result of correlation.
